(19) United States
(12) Patent Application Publication
(10) Pub. No.: US 2025/0223075 A1
(43) Pub. Date: Jul. 10, 2025

(54) Compostable High-Temperature-Resistant Food Tray Liners and Materials

(71) Applicant: Jordan Hidalgo, Belleair, FL (US)

(72) Inventor: Jordan Hidalgo, Belleair, FL (US)

(21) Appl. No.: 19/094,969

(22) Filed: Mar. 30, 2025

(51) Int. Cl. B65D 1/34; B65D 25/16; C08K 3/34; C08L 1/02

(52) U.S. Cl. CPC B65D 1/34; B65D 25/16; C08K 3/346; C08L 1/02; B65D 2581/34; C08L 2201/06; C08L 2201/08

(57) ABSTRACT

A compostable, high-temperature-resistant liner for use in cooking applications, comprising a plant-based fiber matrix incorporating one or more food-safe, heat-resistant components.

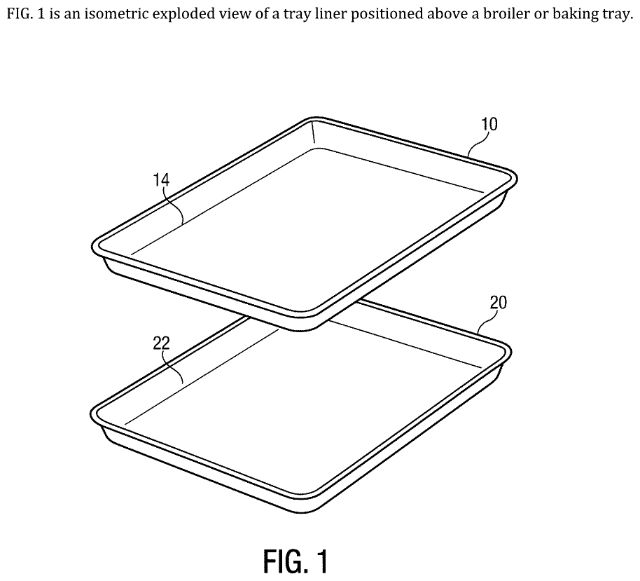

The material may include, but is not limited to, sugarcane bagasse, bamboo, hemp, or similar natural fibers, and may further include heat-resistant additives such as plant-derived waxes, mineral substances including kaolin clay, or comparable compounds.

The liner is suitable for use at temperatures exceeding 500° F. and may be provided as a flat sheet or as a molded insert with raised edges to fit standard broiler or oven trays.

### FIELD OF THE INVENTION

The present invention relates to high-temperature-resistant, compostable materials suitable for use in food-contact applications. More specifically, the invention relates to liners or inserts used in ovens, broilers, or other cooking environments, wherein the material can withstand elevated temperatures while resisting oil absorption and remaining environmentally sustainable.

### BACKGROUND OF THE INVENTION

Conventional broiler and oven tray liners are commonly made of aluminum foil, parchment paper, or polymer-coated paper, each presenting drawbacks. Aluminum foil is non-renewable and difficult to recycle when contaminated with food. Parchment paper may not withstand direct radiant heat and is often coated with silicone, which is not biodegradable. Compostable paper products typically degrade or ignite under high temperatures, making them unsuitable for broiling or high-heat applications.

There remains a need for a heat-resistant, food-safe liner that is both compostable and capable of withstanding temperatures exceeding 500° F., without igniting, degrading, or absorbing oil or moisture. Furthermore, such liners should be suitable for single-use, molded or precut to fit standard cooking trays.

### SUMMARY OF THE INVENTION

The invention provides a plant-based, heat-resistant, compostable cooking liner for use in home and commercial food preparation. The liner may be provided as a flat sheet or as a molded insert with raised edges, designed to conform to standard tray dimensions including eighth sheet, quarter sheet, and half sheet sizes. The material incorporates one or more food-safe, high-temperature-tolerant components, such as plant waxes or mineral-based additives, to achieve thermal stability and a liquid/oil barrier.

### DETAILED DESCRIPTION OF THE INVENTION

Materials: The base substrate comprises a plant-based fiber matrix, including but not limited to sugarcane bagasse, bamboo pulp, hemp fibers, or other agricultural byproducts or cellulosic sources. The fiber matrix may be formed via traditional molded pulp methods, wet-lay processes, or compression molding.

To enhance high-temperature performance and prevent combustion, degradation, or softening, the matrix incorporates one or more heat-resistant, food-safe components, including but not limited to plant-derived waxes (e.g., carnauba wax, candelilla wax), mineral substances such as kaolin clay, mica, or diatomaceous earth, or other natural or food-safe compounds. These components may be applied as a surface coating, blended into the substrate, or both. In some embodiments, the material is a single continuous composite with no separate coating.

Construction and Form Factor: The liner may be formed in at least two configurations:
1. Flat Sheet Liner: In a roll or precut to fit standard tray sizes (eighth sheet, quarter sheet, half sheet); may be perforated or scored for folding; designed to sit flush on the cooking surface.
2. Molded Tray Insert: Pre-formed to fit within the contours of a tray or pan; includes raised edges to retain juices, oils, and food; may include reinforced corners, textured bottom, or stackable design for packaging.

Performance Characteristics: Withstands direct radiant heat of at least 500° F. (260° C.), with potential performance up to 600° F. (315° C.); maintains structural integrity during and after cooking; provides an oil and liquid barrier; compliant with food safety standards (e.g., FDA GRAS or EU equivalents); certified compostable under ASTM D6400, EN 13432, or equivalent conditions for home or industrial composting; free from petroleum-based plastics or synthetic coatings.

Use Cases: Broiling fish, meat, or vegetables; baking or roasting greasy or marinated foods; air fryer trays and toaster ovens; commercial kitchens seeking eco-friendly alternatives to foil.

1. A compostable, high-temperature-resistant material for use in food-contact applications, comprising: a plant-based fiber matrix incorporating one or more food-safe, heat-resistant components, wherein the material is capable of withstanding exposure to temperatures of at least 500° F. (260° C.) without structural degradation, ignition, or loss of food-contact integrity.

2. The material of claim 1, wherein the plant-based fiber matrix comprises one or more natural fibers including, but not limited to, sugarcane bagasse, bamboo, hemp, or similar cellulosic sources.

3. The material of claim 1, wherein the heat-resistant component comprises one or more food-safe additives including, but not limited to, plant-derived waxes, mineral substances such as kaolin clay, or comparable compounds.

4. A single-use cooking liner formed from the material of claim 1, wherein the liner is shaped as either: (a) a flat sheet for use on oven-safe trays or pans, or (b) a molded insert with one or more raised edges to conform to the interior shape of a cooking tray or broiler pan.

5. The liner of claim 4, wherein the liner is dimensioned to fit at least one of a standard eighth sheet, quarter sheet, or half sheet tray.

6. The liner of claim 4, wherein the material is substantially resistant to oil or grease absorption and forms a liquid barrier suitable for use with high-fat or high-moisture foods during cooking.

7. The liner of claim 4, wherein the material is certified compostable under industrial or home composting conditions in accordance with applicable environmental standards.

8. The liner of claim 4, wherein the material meets applicable food-contact safety standards as defined by the U.S. Food and Drug Administration or equivalent international regulatory authorities.

9. The liner of claim 4, wherein the liner is suitable for use in high-temperature cooking environments including, but not limited to, oven broilers, convection ovens, toaster ovens, and air fryers.
